(19) United States
(12) Patent Application Publication
(10) Pub. No.: US 2021/0331455 A1
(43) Pub. Date: Oct. 28, 2021

(54) Biaxially oriented, single- or multilayer polyester film having an adhesion promoter coating based on a copolyester and an anchor component

(71) Applicant: Mitsubishi Polyester Film GmbH, Wiesbaden (DE)

(72) Inventors: Stefan BARTSCH, Bodenheim (DE); Holger KLIESCH, Ginsheim (DE); Viktor FISCHER, Oftersheim (DE); Tobias RENTZSCH, Bad Homburg (DE)

(73) Assignee: Mitsubishi Polyester Film GmbH, Wiesbaden (DE)

(21) Appl. No.: 17/236,527

(22) Filed: Apr. 21, 2021

(30) Foreign Application Priority Data
Apr. 23, 2020 (DE) 10 2020 205 192.5

(51) Int. Cl. B32B 27/36; C08J 5/18; C08G 63/688; C08G 77/18; B32B 27/08; B32B 27/28; B32B 37/15

(52) U.S. Cl. CPC B32B 27/36; C08J 5/18; C08G 63/6886; C08G 77/18; B32B 2307/75; B32B 27/283; B32B 37/153; B32B 2307/4023; B32B 2307/518; B32B 27/08

(57) ABSTRACT

The invention relates to a polyester film provided with a coating at least on one side, wherein the coating is the drying product of an aqueous dispersion, the composition of which comprises not only water but also at least one copolyester component and one silane component, where
the copolyester component is formed to an extent of 3 to 35 mol % of a monomer unit bearing sulfonate groups, and is present in the dried coating in a proportion of 40-85% by weight, and
the silane component bears vinyl groups or methacryloyl groups, and also alkoxy groups, and is present in the dried coating to an extent of 15-60% by weight. The invention further relates to a process for production thereof and to the use thereof.

### CROSS-REFERENCE TO RELATED APPLICATIONS

This application claims priority to German Patent Application 2020 205 192.5 filed Apr. 23, 2020 which is hereby incorporated herein by reference in its entirety.

### FIELD OF THE INVENTION

The invention relates to a single- or multilayer, biaxially oriented polyester film having an adhesion promoter coating applied inline at least on one side, which is formed from at least one copolyester and at least one anchor component. The film according to the invention is of excellent suitability for printing with various printing inks, especially UV printing inks.

### BACKGROUND OF THE INVENTION

Polyester films are used in very many different sectors. Their surface is frequently coated with other materials. For this coating to succeed, the surface must firstly be wettable with the coating material, and the coating material must secondly have sufficiently good adhesion to the polyester substrate. In some cases, this is possible directly on the surface of the polyester film, or by pretreatment of the surface by means of corona or plasma treatment. The surface properties of the polyester films can be altered in a more controlled manner by chemical pretreatment by means of a coating which is applied in the production process for the polyester film itself. This coating then acts as an adhesion promoter layer between the actual polyester film and the actual coating material, for example the decorative print.

There has been sufficient description of polyester films with an adhesion-promoting coating; see, for example, DE 10035327 A1. Copolyester coatings have also been described as an adhesion-promoting layers; see, for example, EP-A 0 144 878, whose United States equivalent is U.S. Pat. No. 4,493,872, which is hereby incorporated by reference herein. However, the copolyester layers described in EP-A 0 144 878 are moisture-sensitive and can be washed off very easily. Especially when the subsequent processing steps work with aqueous media (e.g. printing inks or coating dispersions), adhesion is often not good. The moisture sensitivity of these layers is likewise known; see, for example, https://www.eastman.com/Literature Center/P/POLEUCOAT002.pdf. A known method of improving the adhesion of layers to the substrate and simultaneously of increasing the solvent resistance thereof is the introduction of a crosslinker that reacts both with the substrate (the polyester film here) and with the crosslinking medium. Epoxides having good reactivity with polyesters and the crosslinking of sulfo copolyesters with epoxides is described, for example, in U.S. Pat. No. 5,350,601. But such epoxy compounds have the disadvantage that they are suspected of being genotoxic, and production is therefore associated with risks, but the use of a coating having such components in applications for food contact is especially also forbidden.

As well as the avoidance of risks to health in production, direct reusability of unsaleable film residues that are obtained in production is crucial for the economic producibility of the film. These film residues are collected, shredded and fed back to the process either as shreddings or, after prior extrusion and pelletization, as regenerated material. This must not lead to gel formation or to any change in colour of the film.

In addition, it is very important for the applications mentioned that the coating is largely free of defects, i.e. free of streaks and any significant inclusions, since these would distort the printed image, or in a metal layer for example would be immediately perceived as being unsightly.

### Problem

The polyester films according to the prior art are disadvantageous either because they do not have sufficient adhesion of the adhesion-promoting copolyester coating on the polyester and/or to the target coating medium, or/and contain components that prevent use in applications for food contact for example, or reduce economic producibility by the need to take special safety measures in production. The problem addressed by the present invention was accordingly that of providing a polyester film having a copolyester-containing coating that has good adhesion to printing inks, especially UV printing inks, and is also stable under most conditions. The polyester film is additionally to be producible in an economically viable manner. More particularly, the film is to be free of components bearing epoxy functions that would be a barrier to use in applications for food contact.

### SUMMARY OF ADVANTAGEOUS EMBODIMENTS OF THE INVENTION

The problem is solved by a multilayer polyester film provided with a coating at least on one side, wherein the coating is the drying product of an aqueous dispersion, the composition of which comprises at least one copolyester component and one silane component, where
the copolyester component is formed to an extent of 3 to 35 mol % of a monomer unit bearing sulfonate groups, and is present in the dried coating in a proportion of 40-85% by weight, and
the silane component bears vinyl groups or methacryloyl groups, and also alkoxy groups, and is present in the dried coating to an extent of 15-60% by weight.

### DETAILED DESCRIPTION OF ADVANTAGEOUS EMBODIMENTS OF THE INVENTION

The total film thickness is at least 4 μm and at most 500 μm. The film thickness is preferably at least 10 and at most 250 μm, and ideally at least 11.5 μm and at most 125 μm. If the film thickness is below 4 μm, the mechanical strength of the film is no longer sufficient to be printable with good quality. Above 500 μm, the film becomes too stiff to be coatable in line with good quality. Even above a film thickness of 250 μm, coating quality visibly decreases owing to the high stiffness of the film, which is manifested, for example, in the form of uncoated sites that are visually perceptible as spots.

The film has a base layer B. Single-layer films consist solely of this base layer B. In a multilayer embodiment, the film consists of the (i.e. one) base layer B and at least one fibre layer which, according to its positioning in the film, is referred to as interlayer (in which case there is at least one further layer on each of the two surfaces) or outer layer (the layer forms an outer layer of the film). In the case of the multilayer execution, the thickness of the base layer B is at least as high as the sum total of the other layer thicknesses. The thickness of the base layer in multilayer embodiments is preferably at least 55% of the total film thickness and ideally at least 63% of the total film thickness. If the outer layers become too thick, there is a drop in economic viability since there is likewise a drop in the maximum usable content of regenerated material. For reasons of assurance of properties, regenerated materials (recycled film residues from film production) should be supplied only to the base. If the base layer thickness were too small compared to the total thickness, it would then be necessary to supply this base layer with an excessive percentage of regenerated material to close the regenerated material circuit. Even via the base layer, this can have an adverse effect on the properties, for example colour and transparency, of the film. Moreover, outer layers generally contain particles for improving slip properties (improvement of windability). In thick outer layers, these particles lead to a loss of transparency and to haze as a result of backscatter. Especially in graphic applications—like the present application—what are preferred, however, are films having low haze and high transparency, which is adversely affected by too many particles.

The base layer B consists at least to an extent of 70% by weight of a thermoplastic polyester; the remaining constituents are formed by additives such as UV stabilizers, particles, flame retardants, polyolefins, cycloolefin copolymers (COCs) and other additives and/or polymers compatible with polyesters, for example polyamides. According to the invention, the other additives and/or polymers compatible with polyesters (for example polyamide) are present in the base layer B to an extent of 20% by weight, preferably to an extent of 2% by weight and more preferably not at all. The use of other additives and/or polymers, in the case of recycling of the regenerated material in the film production process, can lead to unwanted yellowing of the film, which makes it necessary to reduce the proportion of regenerated material and hence lowers the economic viability of the process. In addition, the use of other additives can lead to a deterioration in the mechanical properties of the film.

Suitable thermoplastic polyesters have been found to include polyesters formed from ethylene glycol and terephthalic acid (=polyethylene terephthalate, PET), from ethylene glycol and naphthalene-2,6-dicarboxylic acid (=polyethylene-2,6-naphthalate, PEN), furan-2,5-dicarboxylic acid and ethylene glycol, and of any mixtures of the carboxylic acids and diols mentioned. Preference is given to polyesters consisting to an extent of at least 75 mol %, preferably at least 90 mol % and more preferably at least 92 mol % of ethylene glycol and terephthalic acid units. The use of naphthalene-2,6-dicarboxylic acid has no advantages over the use of terephthalic acid, and so it is typically dispensed with due to the higher cost of naphthalene-2,6-dicarboxylic acid. Furan-2,5-dicarboxylic acid is generally not used either on account of its higher cost. The remaining monomer units stem from other aliphatic, cycloaliphatic or aromatic diols or dicarboxylic acids.

Other suitable aliphatic diols are, for example, diethylene glycol, triethylene glycol, aliphatic glycols of the general formula HO—(CH₂)ₙ—OH where n is preferably less than 10, cyclohexanedimethanol, butanediol, propanediol, etc. Suitable other dicarboxylic acids are, for example, isophthalic acid, adipic acid etc.

A polyester according to this above description constitutes the main constituent, i.e. at least 70% by weight, of the base layer B, and also the main constituent, i.e. at least 70% by weight, of the other layers of the film.

The film of the invention has an SV of >600, preferably of >650, and more preferably of >700. The SV of the film is <950 and preferably <850. If the SV is below 600, the film becomes so brittle even in the course of production that there are frequent breaks. Moreover, in the final applications, there is a faster further loss of viscosity with loss of flexibility of the films, resulting in breakage. Moreover, the mechanical strengths mentioned further down are no longer reliably achieved in the case of a relatively small SV.

If the film is to have a higher SV than 950, the polymers used for film production would then have to have an SV of at least 950. However, these would remain so viscous in the melt in the extruder that excessively high currents would occur in the operation of the electric extruder motors and there would be fluctuations in pressure in the explosion, which would lead to poor productivity.

The SV of the film depends on the SV of the raw materials used, and on the chosen process conditions. For instance, the extrusion of the raw materials, as a result of the mechanical stress (through shear) and for temperature-related reasons, results in a decrease in the SV. In order to adjust the SV of the film, it is thus necessary to compensate for the extrusion-related decrease in SV by using raw materials having a correspondingly higher SV. The extent of the extrusion-related decrease in SV is a machine-specific variable that has to be found out separately for every film production plant.

If multiple raw materials having different SV are used, an averaged SV can be assumed for the raw material mixture. The averaged SV is calculated as the sum total of the SV values of the raw material components (SVᵢ) weighted by their proportion by mass (wᵢ):

$$SV = {\sum }_{i} ( {SV}_{i} \cdot {w}_{i} )$$

Whitening polymers which, however, are incompatible with the main polyester constituent, such as polypropylene, cycloolefin copolymers (COCs), polyethylene, uncrosslinked polystyrene etc., in the context of the invention, are present to extent of less than 0.1% by weight (based on the weight of the film) and ideally not at all (to extent of 0% by weight), since these greatly reduce transparency, adversely affect fire performance and, under regeneration conditions (production and recycling of the regenerated material), lead to significant yellowing, which distinctly worsens economic viability.

Base and outer layer(s) may contain particles for improvement of windability. Such inorganic or organic particles are, for example, calcium carbonate, apatite, silicon dioxide, aluminium oxide, crosslinked polystyrene, crosslinked polymethylmethacrylate (PMMA), zeolites and other silicates such as aluminium silicates, or else white pigments such as TiO₂ or BaSO₄. These particles are preferably added to the outer layers for improvement of windability of the film. In a preferred transparent embodiment, preference is given to the use of silicon dioxide-based particles since these have little transparency-reducing effect. The proportion of these or other particles, in a preferred transparent embodiment, is not more than 3% by weight in any layer, preferably below 1% by weight and more preferably below 0.2% by weight in each layer (based in each case on the total weight of the layer in question). In the case of a multilayer embodiment, these particles are preferably added only to one or both outer layers, and hence get into the base layer via the regenerated material only in a small proportion. In this way, a minimal reduction in transparency is achieved by the particles required for the winding. At least one outer layer preferably contains at least 0.07% by weight of these particles.

In further preferred embodiments, the film is white. In these embodiments, the film contains at least one white pigment, preferably titanium dioxide or barium sulfate. The white pigment content here, based on the total weight of the film, is at least 1% by weight, preferably at least 3% by weight and more preferably at least 5% by weight. The proportion of white pigment is <38% by weight and preferably <20% by weight and ideally <15% by weight. The higher the proportion of white pigment, the more hidingly white the film, but the lower the productivity, since there are increased film breaks in the production process.

In a further preferred embodiment, the film is matt on at least one side. In these cases, the film contains an inorganic and/or organic particle system. Without restriction thereto, examples of these can be found in EP-A 1 197 327. It is also possible to use mutually incompatible polymers for creation of matt surfaces.

Coating

The film according to the invention contains an adhesion-promoting coating at least on one side. This coating is preferably applied inline. What is meant by inline is that the coating is applied in the process for production of the polyester film prior to the first rolling-up. The coating can also be applied offline, but since an additional unwinding and winding step is needed for this purpose, this is generally economically unviable.

The coating of the ready-to-use film has a thickness of 5-170 nm. The thickness is preferably 10-130 nm and ideally 20-110 nm. The thicker the coating within this range of the invention up to about 50 nm, in general, the better the adhesion-promoting effect. Layer thicknesses greater than 50 nm are possible, but are no longer accompanied by an increase in the adhesion-promoting effect to the same degree, and therefore offer barely any advantages over 50 nm. The thicker the coating, the clearer the occurrence of coating irregularities as well. Over and above 170 nm, defect-free application is no longer possible inline.

The coating consists essentially of a copolyester component and a silane component. It is suspected that the promotional adhesion is attributable mainly to the copolyester component, and the silane compound brings crosslinking of the copolyester to give good anchoring to the polyester substrate.

The epoxysilanes described in U.S. Pat. No. 5,350,601 (e.g. (3-glycidyloxypropyl)-trimethoxysilanes) that enable good anchoring of the coating to the film surface are not an option for reasons of toxicity. By contrast, U.S. Pat. No. 5,350,601 attested only inadequate anchoring action for other silanes having non-epoxy functionalization. Nor is there any apparent route to a solution for crosslinking polyesters in the document “Geniosil—Organofunktionelle Silane von Wacker” [Geniosil—Organofunctional Silanes from Wacker] (retrieved in 2018 at https://www.wacker.com/cms/media/publications/downloads/6085 DE.pdf), if epoxysilanes are not an option.

Contrary to expectation, it was found that, surprisingly, a relatively small selection of silanes having vinyl group functionalization, or less preferably methacryloyl group functionalization, nevertheless enables very good anchoring action of the copolyester-containing coating component with respect to the polyester film substrate.

It is suspected that the alkoxy groups, or less preferably acetoxy groups, after hydrolysis in the aqueous dispersion medium enter into a condensation reaction with terminal hydroxyl groups of the copolyester or the polyester film substrate. The vinyl group function apparently promotes the further crosslinking of the silanes with one another to an extent similar to that enabled by epoxy functions.

Especially ethoxysilanes having short-chain vinyl functionalization appear to be particularly suitable with regard to gel formation characteristics in the aqueous coating dispersion and anchoring function on the film substrate.

Copolyesters in the Coating

The copolyester component in the coating is the product of a polycondensation of dicarboxylic acid and diol units, with various possible monomers for the dicarboxylic acid component in particular, for example terephthalic acid and/or isophthalic acid.

A (homo)polyester is formed from a dicarboxylic acid unit and a diol unit. A copolyester is formed from at least two different dicarboxylic acid units and/or at least two different diol units. The copolyester in the coating contains, in the dicarboxylic acid moiety, in addition to monomers bearing no sulfonate groups, at least one monomer bearing sulfonate groups. Suitable monomers bearing sulfonate groups are described in EP-A 0 144 878. Preference is given, however, to salts of 5-sulfoisophthalic acid. The counterion is of minor importance, but is generally sodium or hydrogen. 5-Sulfoisophthalic acid (counterion=H⁺) can be used with the best yields in the polymerization and leads to a thermally stable polymers that do not lead to thermal breakdown in the production process for the film. Further suitable dicarboxylic acids without sulfonate groups can likewise be found in EP-A 0 144 878, but preference is given to terephthalic acid and isophthalic acid, for reasons including those already given for 5-sulfoisophthalic acid (5-SIPA). Particular preference is given to isophthalic acid, since the use of isophthalic acid leads to a particular good water solubility of the resulting polymers, which is advantageous for the production of the coating dispersions. The proportion of isophthalic acid in the monomer units that do not bear sulfonate groups in the dicarboxylic acid moiety is therefore preferably greater than 50 mol % and more preferably greater than 75 mol % and ideally greater than 85 mol %. The proportion of the monomers bearing sulfonate groups in the dicarboxylic acid moiety is between 2 and 50 mol %, preferably between 6 and 30 mol % and ideally between 8 and 15 mol %. Below 2 mol % polymers no longer have sufficient water solubility, and below 6 mol % are only sparingly water-soluble (the decisions would have to be heated). Above 15 mol % there is a distinct increase in the moisture sensitivity of the coating. Above 30 mol % the polymers are additionally preparable only with low yields.

The suitable diols can also be found in EP-A 0 144 878. Preference is given to using ethylene glycol, diethylene glycol (DEG), polyethylene glycol (PEG), propanediol, or cyclohexane-1,4-dimethanol (CHDM). Particular preference is given to ethylene glycol (EG), since this results in a particularly thermally stable polymer that has the lowest cost owing to its wide use in industry.

Such polymers or dispersions thereof are commercially available, for example, under the EASTEK® brand name from Eastman Chemical (USA).

It has additionally found to be favorable when the glass transition temperature of the copolyesters used is well above room temperature since the adhesion of layers applied thereto is not subject to any changes when there are brief temperature events above room temperature during further processing or storage. In a preferred embodiment, the glass transition temperature of the copolyesters used is therefore >35° C., preferably >50° C. and ideally >65° C. Higher glass transition temperatures are achievable when further dicarboxylic acids are used as well as 5-SIPA, isophthalic acid and terephthalic acid. However, aliphatic dicarboxylic acids, for example maleic acid, lead to a reduction in glass transition temperature. Diols other than ethylene glycol should be avoided, especially CHDM.

Silane in the Coating

As well as the copolyester, the coating dispersion contains at least one silane bearing vinyl groups (or methacryloyl groups). This silane complies with the following general formula:

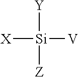

where

X, Y, Z are independently the same or different and are CH₃—CO₂— or (CH₃—(CH₂)ₙ)ₘ—CHₚ—O—, with
n=0-4, preferably 0,
m=3-p,
p=0-2, preferably 2,

or less preferably

Z═(CH₃— (CH₂)_{f})_{g}—CHₕ with
f=0-4
g=3-h
h=0-2

and

V is a radical bearing at least one vinyl group, preferably

V=—(CH₂)ₑ—CH═CH₂, with
e=0-4 and preferably =0,

less preferably

V=—(CH₂)_{d}—O—CO—C(CH₃)═CH₂, with
d=1-4

It is particularly preferable that X═Y═Z and is more preferably CH₃CH₂—O—, since, in that case, the hydrolysis reaction in aqueous coating dispersion eliminates ethanol, which is easier to handle in production operation than, for example, methanol and alcohols. Of course—from a purely functional point of view—p may also be 3.

In a less preferred embodiment, it is also possible for one or more of the X,Y,Z radicals to be an acetoxy radical—(CO₂—CH₃). The other non-acetoxy radicals then conform to the above-specified formulae for X—Z. However, acetoxy radicals, especially at relatively high concentrations of the silane, lead to gel formation in the coating dispersion, which, after a short time (<6 h), already leads to distinct deterioration in the coating quality.

Particularly effective vinylsilanes have been found to be those in which the vinyl group is bonded directly to the silicon. If there are CH₂ groups between Si and vinyl function, or methacryloylsilanes are used (less preferred variants of V), especially at higher concentrations of the silane, there is gel formation in the coating dispersion, which, after a short time (<6 h), already leads to distinct deterioration in the coating quality.

Coating Dispersion

In a preferred embodiment, the coating dispersion contains water as dispersant, and the copolyester and the silane in the following amounts:

The coating dispersion contains at least 0.3% by weight, preferably at least 1% by weight and more preferably at least 2% by weight of the copolyesters according to the invention. The copolyester content is not more than 9% by weight, preferably not more than 6% by weight and ideally not more than 3.5% by weight.

The coating dispersion contains at least 0.3% by weight, preferably at least 0.6% by weight and more preferably at least 1% by weight of the silanes according to the invention. The silane content is not more than 3% by weight, preferably not more than 2.3% by weight and ideally not more than 1.8% by weight.

If the silane or copolyester content is too low, there is no ideal film formation since too much water has to be evaporated. If the silane or copolyester content is too high, gel formation is faster and there is a deterioration in coating quality. The best results are achieved within the abovementioned limits.

The silane content in % by weight is preferably lower than that of the copolyester content in % by weight and is more preferably 75% of the amount of the copolyester in % by weight. This leads to a reduced tendency to crosslinking within the coating dispersion and hence to better coating quality even in the case of a prolonged production time.

The coating dispersion may contain further components such as surfactants for improvement of wetting, defoamers, or particles for improving slip properties.

The coating dispersion does not contain any components bearing epoxy functions, since these could get into the ambient air in the course of production, or residues thereof can migrate out of the coating at a later stage, and hence use in contact with food or in contact with skin (for example medical applications) would not be possible.

Process for Applying the Coating

In the preferred embodiment, the adhesion-promoting coating is applied inline in the production process for the biaxially oriented polyester film. The application of the coating (on one side) or of the coatings (on both sides) is effected here after the longitudinal stretching and before the transverse stretching (or less preferably, in the case of a simultaneous stretching system, before the longitudinal and transverse stretching). In order to achieve good wetting of the polyester film with the water-based coating, the film surface(s) is/are preferably first corona-treated. The coating(s) can be applied by suitable standard methods, such as with a slot caster or by a spraying method. Particular preference is given to the application of the coating(s) by means of the reverse gravure-roll coating method, in which the coating(s) can be applied in an extremely homogeneous manner. Preference is likewise given to application by the Meyer rod method, with which greater coating thicknesses can be achieved. The coating components can react with one another during the drying and stretching of the polyester film and particularly in the subsequent heat treatment, which can reach up to 240° C. The in-line method is more economic attractive here since one or both coatings can be applied simultaneously with the process for production of the film, and so it is possible to dispense with one process step (see below: offline method).

In an alternative, less preferred method, one or both coatings are applied by offline methodology. The coating according to the present invention is applied here to the corresponding surface(s) of the polyester film by means of offline technology in an additional process step downstream of the film production, using a forward gravure roll for example. The upper limits for the coating thickness are fixed by the process conditions and the viscosity of the coating dispersion, and find their upper limit in the processibility of the coating dispersion.

Processes for Film Production

The polyester polymers of the individual layers are produced by polycondensation, either proceeding from dicarboxylic acids and diol or else proceeding from the esters of the dicarboxylic acids, preferably the dimethyl esters, and diol.

Polyesters usable for film production may have SV values within a range from preferably 500 to 1300. A crucial factor for the later film production is not the SV of a single material component but the SV averaged over all the raw material components of the mixture intended for extrusion. According to the invention, this averaged SV is greater than 700, and preferably greater than 750.

The particles—if present—may be added as early as in the preparation of the polyester. For this purpose, the particles are dispersed in the diol, optionally ground, decanted or/and filters, and added to the reactor, either in the (trans)esterification step or polycondensation step. A concentrated particle-containing or additive-containing polyester masterbatch can be preferably produced with a twin-screw extruder and diluted with particle-free polyester in the film extrusion. It has been found here to be favourable when no masterbatches containing less than 30% by weight of polyester are used. Especially a masterbatch containing SiO₂ particles should not be more than 20% by weight in SiO₂ (owing to the risk of gel formation). A further option is to add particles and additives directly on film extrusion in a twin-screw extruder.

When single-screw extruders are used, it has been found to be advantageous to dry the polyesters beforehand. When a twin-screw extruder with a venting zone is used, it is possible to dispense with the drying step.

First of all, the polyester or polyester mixture of the layer, or of the individual layers in the case of multilayer films, is compressed and liquefied in extruders. Then the melt(s) is/are formed to a flat melt film in a single- or multilayer nozzle, pushed through a slot die and drawn off on one chill roll or one or more draw rolls, where the melt film cools down and solidifies.

The film of the invention is biaxially oriented, i.e. biaxially stretched. The axial stretching of the film is most commonly performed sequentially. Preference is given to stretching first in longitudinal direction (i.e. in machine direction, =MD) and then in the transverse direction (i.e. at right angles to machine direction, =TD). Stretching in longitudinal direction can be performed with the aid of two rolls running at different speed in accordance with the desired stretching ratio. Transverse stretching is generally accomplished using an appropriate tenter frame.

The temperature at which the stretching is conducted may vary within a relatively wide range and is guided by the desired properties of the film. In general, the stretching is conducted in longitudinal direction within a temperature range from 80 to 130° C. (heating temperatures 80 to 130° C.) and in transverse direction within a temperature range from 90° C. (commencement of stretching) to 140° C. (end of stretching). The longitudinal stretching ratio is in the range from 2.5:1 to 4.5:1, preferably from 2.8:1 to 3.4:1. A stretching ratio above 4.5 leads to a distinct deterioration in producibility (break-offs). The transverse stretching ratio is generally from 2.5:1 to 5.0:1, preferably from 3.2:1 to 4:1. A higher transverse stretching ratio than 5 leads to a distinct deterioration in producibility (break-offs) and should therefore preferably be avoided. For achievement of the desired film properties, it has been found to be advantageous when the stretching temperature (in MD and TD) is below 125° C. and preferably below 118° C. Before the transverse stretching, there preferably then follows the in-line coating of one or both surface(s) of the film by the methods known per se. In the subsequent heat-setting, the film is kept under mechanical stress at a temperature of 150 to 250° C. over a period of about 0.1 to 10 s and, to attain the preferred shrinkage values (see below), is relaxed by at least 1%, preferably by at least 3% and more preferably by at least 4% in transverse direction. This relaxation preferably takes place within a temperature range from 150 to 190° C. For reduction of transparency bow, the temperature in the first setting field is preferably below 220° C. and more preferably below 190° C. In addition, for the same reason, at least 1%, preferably at least 2%, of the total transverse stretching ratio should be within the first setting field, in which there is typically no further stretching. Subsequently, the film is wound up in the customary manner.

In a particularly economic viable mode of production of the polyester film, the offcut material (regenerate) can be fed back to the extrusion in an amount of up to 60% by weight, based on the total weight of the film, without significantly adversely affecting the physical properties of the film.

Film Properties

The film according to the invention, by the process described above, preferably has shrinkage in longitudinal and transverse direction at 150° C. of below 5%, preferably below 2% and more preferably below 1.5%. This film still has elongation at 100° C. of less than 3%, preferably of less than 1% and more preferably of less than 0.3%. This dimensional stability can be obtained, for example, by suitable relaxation of the film prior to winding (see process description). This dimensional stability is important in order to avoid deterioration of the printed image, or the coating quality, that can arise in the case of shrinkage or elongation of the film on subsequent printing, coating or metallizing of the film, where temperatures of >100° C. can occur.

Use

The films according to the invention are of excellent suitability for printing from aqueous and solventborne ink systems, especially also for printing with UV printing inks. The latter have particularly good adhesion to the base film on the coating according to the invention. In addition, the films according to the invention have a very good metallizability and have very good metal adhesion. An additional characteristic feature is that adhesion remains very good even after contact with water.

Analysis

The raw materials and films are characterized using the following test methods:

SV (Standard Viscosity)

Standard viscosity in dilute solution (SV), in accordance with DIN 53 728 Part 3, is measured in an Ubbelohde viscometer at (25±0.05°) C. Dichloroacetic acid (DCA) was used as solvent. The concentration of the dissolved polymer was 1 g of polymer/100 ml of pure solvent. The polymer was dissolved at 60° C. for 1 hour.

The relative viscosity (ηᵣₑₗ=η/ηₛ) is used to ascertain the dimensionless SV value as follows:

SV=(ηᵣₑₗ−1)×1000

The method is equally suitable for determination of polyester raw material and of polyester film. The performance of the measurement, including sample preparation, is independent of the sample form. However, the SV of film and the SV of raw material are different properties that are not equivalent to one another, and should be considered separately.

Shrinkage

Thermal shrinkage was determined on square film specimens having an edge length of 10 cm. The samples were cut out in such a way that one edge ran parallel to machine direction and one edge at right angles to machine direction. Samples were measured accurately (the edge length L₀ was determined for each machine direction TD and MD, L_{0 TD} and L_{0 MD}) and subjected to heat treatment at the given shrinkage temperature (150° C. here) in an air circulation drying cabinet for 15 min. The samples were removed and measured accurately at room temperature (edge length L_{TD} and L_{MD}). Shrinkage is calculated from the following equation:

shrinkage[%]MD=100·(L_{0 MD}−L_{MD})/L_{0 MD}, or

shrinkage[%]TD=100·(L_{0 TD}−L_{TD})/L_{0 TD}

Elongation

Thermal elongation was determined on square film specimens having an edge length of 10 cm. The samples were measured accurately (edge length L₀), subjected to heat treatment at 100° C. in an air circulation drying cabinet for 15 minutes, and then measured accurately at room temperature (edge length L). Elongation is calculated from the following equation:

elongation[%]=100*(L−L₀)/L₀

and was ascertained separately in each film direction.

Assessment of Coating Quality

The film is inspected visually over the production width and a length of at least 5 metres. For this purpose, the film is illuminated with a strong light source from various directions and assessed by two people who view the film from different angles. The coating quality is assessed with the following grades:
1. No visible defects (inclusions, streaks, uncoated sites)
2. Minor inclusions (gels etc.) just visible
3. Individual larger, readily apparent inclusions or/and streaks shorter than 1 cm
4. Many larger, readily apparent inclusions or/and streaks longer than 1 cm
5. Larger inclusions virtually over the entire width of the film or/and streaks longer than 1 cm and/or uncoated sites >1 cm²

Over and above grade 4, the coating is no longer commercially utilizable.

Coating quality is assessed initially, i.e. on commencement of production and after 3 hours of production. After 3 hours of production, information as to the stability of the coating dispersion or its tendency to form gels is obtained.

Measurement of Bond Strength

Bond strength on the film is tested for printing inks and metallization by means of the cross-cut method in accordance with EN ISO 2409. A grid of 8×8 lines each at a distance of 2 mm is cut into the coated surface, cutting sufficiently deep as to cut into the polyester film surface, but without severing the film. Subsequently, an adhesive tape (TESAFILM® 4129 from Tesa SE Deutschland) is stuck over the cut area and manually pulled off sharply.

The assessment follows the following scheme:
Rating 0: Completely smooth cut edges. No flaked-off squares in the crosscut.
Rating 1: Small amount of material chipped off at the points of intersection of the crosscut lines. But not more than 5% of the inner grid surfaces.
Rating 2: Material chipped off along the crosscut lines and at the points of intersection of the crosscut lines. But not more than 15% of the inner grid surfaces.
Rating 3: Material chipped off over partial or broad areas along the crosscut lines, and some squares chipped off. But not greater than 35% of the inner grid surfaces.
Rating 4: Material chipped off over broad areas along the crosscut lines and some squares chipped off. But not more than 65% of the inner grid surfaces.
Rating 5: More than 65% of the inner grid surfaces chipped off.

Ratings above 2 are unsuitable for most applications.

Measurement of Bond Strength after Exposure to Moisture

For this purpose, the cross-cut grid is made as described in “Measurement of bond strength”. The cut film is then stored in warm water at 25° C. for 24 h, then removed and dried cautiously with a dry paper towel. Subsequently, the further procedure and assessment are as described in “Measurement of bond strength”.

Measurement of Bond Strength after Exposure to Moisture and Heat

For this purpose, the cross-cut grid is made as described in “Measurement of bond strength”. The cut film is then stored in warm water at 60° C. for 24 h, then removed and dried cautiously with a dry paper towel. Subsequently, the further procedure and assessment are as described in “Measurement of bond strength”.

Printing

The film is printed by offset printing with UV printing inks of the NEWV® poly series from Hubergroup Deutschland GmbH and cured by means of standard mercury UV sources. Yellow, cyan, magenta and black lines of width 3 mm were printed alongside one another.

Metallization

The film is coated under reduced pressure with aluminium, and the optical density of the film thereafter is 2.

Film Production in the Examples

For all the examples adduced, the film was produced as follows. The raw materials below were melted in one extruder per layer at 292° C. and extruded through a three-layer slot die after electrostatic application to a draw roll heated to 50° C. The amorphous pre-film thus obtained was then first stretched longitudinally. The longitudinally stretched film was corona-treated in a corona unit and then coated inline by reverse gravure coating with one of the dispersions below. Thereafter, the film was stretched transversely, heat-set and rolled up. The conditions in the individual process steps were:

| | | | |
|---|---|---|---|
| Longitudinal stretching | Heating temperature | 75-115 | ° C. |
| | Stretching temperature | 115 | ° C. |
| | Longitudinal stretching ratio | 3.8 | |
| Transverse stretching | Heating temperature | 100 | ° C. |
| | Stretching temperature | 112 | ° C. |
| | Transverse stretching ratio | 3.9 | |
| | (including stretching in 1st | | |
| | setting field) | | |
| Setting | Temperature | 237-150 | ° C. |
| | Time | 3 | s |
| | Relaxation in TD at | 5 | % |
| | 200-150° C. | | |
| Setting | Temperature in 1st setting | 170 | ° C. |
| | field | | |

The film in the examples was produced using the following starting materials:

PET1=polyethylene terephthalate raw material made from ethylene glycol and terephthalic acid and having an SV of 820.

PET2=polyethylene terephthalate raw material having an SV of 700 and 15% by weight of amorphous SiO₂, SYLOBLOC® 46 (manufacturer: Grace, Germany); median particle diameter d₅₀ (according to data sheet) 3.6-4.2 μm. The SiO₂ was incorporated into the polyethylene terephthalate in a twin-screw extruder.

A three-layer film of thickness 36 μm was produced. The thickness of each of outer layers A and C was 1.5 μm. The polymer mixture for outer layers A and C was 99% PET1 and 1% PET2. The base B consisted of 50% PET1 and 50% regenerated material.

Film shrinkage at 150° C. was 1.2% in longitudinal direction and 0.1% in transverse direction.

Composition of the Coating Dispersion

Coating 1:

The following composition of the coating solution was used:
90.0% by weight of deionized water
10.0% by weight of EASTEK™ 1400

The individual components were added gradually to deionized water while stirring and stirred for at least 30 min before use.

EASTEK™ 1400 is a commercially available polymer dispersion from Eastman USA with polymer content 30%. The polyester, in the dicarboxylic acid fraction, consists of sulfoisophthalic acid (5-SIPA). Polymer glass transition temperature 29° C.

Coating 2:

The following composition of the coating solution was used:
90.9% by weight of deionized water
9.1% by weight of EASTEK™ 1100

The individual components were added gradually to deionized water while stirring and stirred for at least 30 min before use.

EASTEK™ 1100 is a commercially available polymer dispersion with polymer content 33%. The polyester, in the dicarboxylic acid fraction, consists of sulfoisophthalic acid (5-SIPA) and isophthalic acid, where the isophthalic acid content is greater than that of 5-SIPA. Polymer glass transition temperature 55° C.

Coating 3:

The following composition of the coating solution was used:
90.0% by weight of deionized water
10.0% by weight of EASTEK™ 1200

The individual components were added gradually to deionized water while stirring and stirred for at least 30 min before use.

EASTEK™ 1200 is a commercially available polymer dispersion with polymer content 30%. The polyester, in the dicarboxylic acid fraction, consists of sulfoisophthalic acid (5-SIPA) and isophthalic acid, where the isophthalic acid content is very much greater than that of 5-SIPA.

Polymer glass transition temperature 63° C.

Coating 4:

The following composition of the coating solution was used:
97% by weight of deionized water
3.0% by weight of polyester from Example 1 from EP-A 0 144 878

The individual components were added gradually to deionized water while stirring and stirred for at least 30 min before use.

The polyester, in the dicarboxylic acid fraction, consists of 10 mol % of sulfoisophthalic acid and 90 mol % of isophthalic acid; the diol fraction consists of ethylene glycol. Polymer glass transition temperature 69° C.

Coating 5:

The following composition of the coating solution was used:
97% by weight of deionized water
3.0% by weight of polyester from Example 4 from EP-A 0 144 878

The individual components were added gradually to deionized water while stirring and stirred for at least 30 min before use.

The polyester, in the dicarboxylic acid fraction, consists of 10 mol % of sulfoisophthalic acid and 70 mol % of isophthalic acid and 20 mol % of malonic acid, the diol fraction consists of ethylene glycol. A broad glass transition point at 20° C.

Coating 6:

The following composition of the coating solution was used:
88.5% by weight of deionized water
10.0% by weight of EASTEKm 1400
1.5% by weight of GENIOSIL™ GF56 from Wacker Chemie AG (vinyltriethoxysilane)

The individual components were added gradually to deionized water while stirring and stirred for at least 30 min before use.

Coating 7:

The following composition of the coating solution was used:
89.4% by weight of deionized water
9.1% by weight of EASTEKm 1100
1.5% by weight of GENIOSIL™ GF56 (vinyltriethoxysilane)

The individual components were added gradually to deionized water while stirring and stirred for at least 30 min before use.

Coating 8:

The following composition of the coating solution was used:
88.5% by weight of deionized water
10.0% by weight of EASTEKm 1200
1.5% by weight of GENIOSIL™ GF56 (vinyltriethoxysilane)

The individual components were added gradually to deionized water while stirring and stirred for at least 30 min before use.

Coating 9:

The following composition of the coating solution was used:
95.5% by weight of deionized water
3.0% by weight of polyester from Example 1 from EP-A 0 144 878
1.5% by weight of GENIOSIL™ GF56 (vinyltriethoxysilane)

The individual components were added gradually to deionized water while stirring and stirred for at least 30 min before use.

Coating 10:

The following composition of the coating solution was used:
95.5% by weight of deionized water
3.0% by weight of polyester from Example 4 from EP-A 0 144 878
1.5% by weight of GENIOSIL™ GF56 (vinyltriethoxysilane)

The individual components were added gradually to deionized water while stirring and stirred for at least 30 min before use.

Coating 11:

The following composition of the coating solution was used:
95.35% by weight of deionized water
3.0% by weight of polyester from Example 1 from EP-A 0 144 878
1.65% by weight of GENIOSIL™ GF62 (vinyltriacetoxysilane)

The individual components were added gradually to deionized water while stirring and stirred for at least 30 min before use.

Coating 12:

The following composition of the coating solution was used:
95.45% by weight of deionized water
3.0% by weight of polyester from Example 1 from EP-A 0 144 878
1.55% by weight of GENIOSIL™ XL 32 ((methacryloyloxymethyl)-methyldimethoxysilane)

The individual components were added gradually to deionized water while stirring and stirred for at least 30 min before use.

Coating 13:

The following composition of the coating solution was used:
95.35% by weight of deionized water
3.0% by weight of polyester from Example 1 from EP-A 0 144 878
1.65% by weight of 26040 from Dow Corning Corporation ((3-glycidyloxypropyl)-trimethoxysilane))

The individual components were added gradually to deionized water while stirring and stirred for at least 30 min before use.

Coating dispersion 13 contains a glycidyl component and therefore has to be treated with particular caution in order not to endanger personnel. The level of care that has to be taken in production is therefore much higher, and economic viability is therefore far lower. Use in applications for food contact or medical products that come into contact with the skin is ruled out. This dispersion is therefore not within the scope of the invention and serves merely for comparative purposes.

Coating 14:

The following composition of the coating solution was used:
93.0% by weight of deionized water
3.0% by weight of polyester from Example 1 from EP-A 0 144 878
4.0% by weight of GENIOSIL™ GF56 (vinyltriethoxysilane)

The individual components were added gradually to deionized water while stirring and stirred for at least 30 min before use.

Unless stated otherwise, the coating is applied by the inline process by means of the reverse gravure method. Table 1 below summarizes the formulations, production conditions and resultant film properties:

TABLE 1
Properties of the films from the examples

| Example | CE1 | CE2 | CE3 | CE4 | CE5 | CE6 | CE7 | CE8 | CE9 | E1 | E2 | E3 | E4 | E5 | E6 | E7 | E8 |
|---|---|---|---|---|---|---|---|---|---|---|---|---|---|---|---|---|---|
| Coating dispersion | none | 1 | 2 | 3 | 4 | 5 | 9 | 13 | 14 | 6 | 7 | 8 | 9 | 10 | 9 | 11 | 12 |
| Coating thickness | 0 nm | 35 | 35 | 35 | 35 | 35 | 200 | 35 | 35 | 35 | 35 | 35 | 35 | 35 | 12 | 35 | 35 |
| Initial coating | — | 2 | 1 | 1 | 1 | 1 | 3 | 1 | 2 | 2 | 1 | 1 | 1 | 1 | 1 | 1 | 1 |
| quality | | | | | | | | | | | | | | | | | |
| Coating quality | — | 3 | 1 | 1 | 1 | 1 | 4 | 2 | 4 | 3 | 1 | 1 | 1 | 1 | 1 | 1 | 3 |
| after 3 h | | | | | | | | | | | | | | | | | |
| Bond strength of | 3 | 3 | 2 | 2 | 2 | 2 | 0 | 0 | 1 | 1 | 0 | 0 | 0 | 0 | 0 | 0 | 0 |
| UV print | | | | | | | | | | | | | | | | | |
| Bond strength of | 4 | 4 | 3 | 3 | 3 | 3 | 0 | 1 | 2 | 1 | 0 | 0 | 0 | 1 | 1 | 0 | 0 |
| UV print after | | | | | | | | | | | | | | | | | |
| moisture exposure | | | | | | | | | | | | | | | | | |
| Bond strength of | 5 | 5 | 5 | 4 | 3 | 5 | 1 | 2 | 2 | 2 | 2 | 1 | 0 | 2 | 1 | 0 | 1 |
| UV print after | | | | | | | | | | | | | | | | | |
| heat/moisture | | | | | | | | | | | | | | | | | |
| exposure | | | | | | | | | | | | | | | | | |
| Bond strength of | 2 | 1 | 1 | 1 | 1 | 1 | 1 | 1 | 1 | 1 | 1 | 1 | 1 | 1 | 1 | 1 | 1 |
| metallization | | | | | | | | | | | | | | | | | |
| Bond strength of | 3 | 3 | 3 | 2 | 2 | 3 | 1 | 1 | 1 | 1 | 1 | 1 | 1 | 1 | 1 | 1 | 1 |
| metallization after | | | | | | | | | | | | | | | | | |
| moisture exposure | | | | | | | | | | | | | | | | | |
| Bond strength of | 3 | 4 | 3 | 3 | 2 | 4 | 2 | 2 | 1 | 2 | 2 | 1 | 1 | 2 | 2 | 1 | 1 |
| metallization after | | | | | | | | | | | | | | | | | |
| heat/moisture | | | | | | | | | | | | | | | | | |
| exposure | | | | | | | | | | | | | | | | | |

That which is claimed:

1. A polyester film comprising a coating on at least on one side, wherein the coating is a dried product of an aqueous dispersion, the coating composition comprising not only water but also at least one copolyester component and one silane component, wherein
the copolyester component comprises 3 to 35 mol % of a monomer unit bearing sulfonate groups, and is present in the dried coating in a proportion of 40-85% by weight, and
the silane component comprises vinyl groups or methacryloyl groups, and also alkoxy groups, and is present in the dried coating to an extent of 15-60% by weight.

2. The polyester film according to claim 1, wherein the film is a multilayer film.

3. The polyester film according to claim 1, wherein the coating has a thickness of 5 to 170 nm.

4. The polyester film according to claim 1, wherein the aqueous dispersion does not contain any components bearing epoxy functions.

5. The polyester film according to claim 1, wherein the copolyester in the coating contains units derived from 5-sulfoisophthalic acid as a dicarboxylic acid moiety.

6. The polyester film according to claim 1, wherein the copolyester in the coating contains units derived from terephthalic acid and/or isophthalic acid as a dicarboxylic acid moiety.

7. The polyester film according to claim 1, wherein the copolyester in the coating has a glass transition temperature of >35° C.

8. The polyester film according to claim 1, wherein the silane bearing vinyl groups or methacryloyl groups has the general formula: 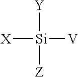
where X, Y, Z are independently the same or different and are CH₃—CO₂— or (CH₃—(CH₂)ₙ)ₘ—CHₚ—O—, with
n=0-4,
m=3-p,
p=0-2
and
V is a radical bearing at least one vinyl group.

9. The polyester film according to claim 1, wherein the silane bearing vinyl groups or methacryloyl groups has the general formula: 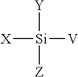
where
X, Y, Z are independently the same or different and are CH₃—CO₂— or (CH₃—(CH₂)ₙ)ₘ—CHₚ—O—, with
n=0-4,
m=3-p,
p=0-3
and
V is a radical bearing at least one vinyl group.

10. The polyester film according to claim 1, wherein the aqueous dispersion contains at least 0.3% by weight of silane component and/or 0.3% by weight of copolyester.

11. The polyester film according to claim 1, wherein the content in % by weight of the silane component is smaller than that of the copolyester component.

12. A process for producing a polyester film according to claim 1 comprising
compressing and liquefying the polyester or a polyester mixture of a layer, or of individual layers in the case of a multilayer film, in (an) extruder(s);
forming the resultant melt(s) in a single- or multilayer nozzle into a flat melt film,
pushing the flat melt film through a slot die to form a pre-film and drawing the pre-film off onto a chill roll and one or more draw rolls to consolidate it,
biaxially orienting the cooled and consolidated melt film and,
inline coating the film before, during or after biaxially orienting, with an aqueous dispersion that is subsequently dried,
wherein the dispersion comprises not only water but also at least one copolyester component and one silane component, wherein
the copolyester component comprises to an extent of 3 to 35 mol % of a monomer unit bearing sulfonate groups, and the copolyeter component is present in the dried coating in a proportion of 40-85% by weight, and
the silane component comprises vinyl groups or methacryloyl groups, and also alkoxy groups, and the silane component is present in the dried coating to an extent of 15-60% by weight,
and heat-setting, relaxing and rolling up the dried coated film.

13. Printed film comprising the film according to claim 1 printed with an aqueous and/or solventborne ink system.

14. Printed film according to claim 13, wherein the ink is a UV printing ink.

15. Metallized film comprising the film according to claim 1.
